(19) United States
(12) Patent Application Publication
(10) Pub. No.: US 2026/0064623 A1
(43) Pub. Date: Mar. 5, 2026

(54) COMMUNICATION OF MEDIA CONFIGURATION INFORMATION OVER A SERIAL COMMUNICATION INTERFACE

(71) Applicant: Intel Corporation, Santa Clara, CA (US)

(72) Inventors: Nishant S. Shah, Portland, OR (US); Kent C. Lusted, Beaverton, OR (US)

(73) Assignee: Intel Corporation, Santa Clara, CA (US)

(21) Appl. No.: 19/106,586

(22) PCT Filed: Sep. 14, 2023
(86) PCT No.: PCT/US2023/074165

§ 371 Date: Feb. 25, 2025

Related U.S. Application Data
(60) Provisional application No. 63/412,851, filed on Oct. 3, 2022.

(51) Int. Cl. G06F 13/42; H04L 12/40

(52) U.S. Cl. CPC G06F 13/4282; H04L 12/40032

(57) ABSTRACT

A host device comprising first circuitry to receive one or more packets sent by a communication device over a serial communication interface between the communication device and the host device, wherein the one or more packets comprise media configuration information stored in a memory of the communication device and an indication of a mapping of the memory of the communication device; and second circuitry to transmit data packets over the serial communication interface after the host device has been configured based on the media configuration information.

### CROSS REFERENCE TO RELATED APPLICATION

This application claims the benefit of and priority from U.S. Provisional Patent Application No. 63/412,851 entitled “COMMUNICATION OF MEDIA CONFIGURATION INFORMATION OVER DATA CHANNELS,” filed Oct. 3, 2022, the entire disclosure of which is incorporated herein by reference.

### BACKGROUND

A computing system may comprise host logic coupled to a connector. The connector may couple to a communication device (e.g., comprising at least one connector and a communication medium) that may couple to another connector (e.g., of another computing system).

### BRIEF DESCRIPTION OF THE DRAWINGS

FIG. 1 illustrates connectivity of an example platform.

FIG. 2 illustrates connectivity of another example platform in which media configuration information is communicated over a serial communication interface.

FIG. 3 illustrates a format for a Next Page.

FIG. 4 illustrates an example Next Page encoding.

FIGS. 5A-5B illustrate example Next Page encodings for an SFF-8072 25GBASE-SR module.

FIGS. 6A-6B illustrate example Next Page encodings for an SFF-8636 100GBASE-SR2 QSFP28 module.

FIG. 7 illustrates example Next Page encodings for a 400GBASE-DR4 QSFP-DD module.

FIG. 8 illustrates a flow for communicating media configuration information over a serial communication interface.

FIG. 9 illustrates an example computing system in which media configuration information may be communicated over at least one data channel.

FIG. 10 illustrates an example host device and an example communication device.

Like reference numbers and designations in the various drawings indicate like elements.

### DETAILED DESCRIPTION

To bring up a link in an input/output (I/O) subsystem (e.g., an Ethernet subsystem), system vendors may rely on a combination of low speed interfaces (such as Inter-Integrated Circuit (I2C), Management Data Input/Output (MDIO), Module_Abs/Present, etc.) and high-speed interfaces (e.g., serial communication interfaces) for pluggable interfaces. For example, for a Network Interface Card (NIC), Integrated Ethernet System on Chip, or Ethernet Switch, when a communication device (e.g., comprising Ethernet media) is connected to the system it is expected that a low speed connection is made to the host or a controller.

Communication devices (also referred to as pluggable module or media), such as Ethernet media/modules (e.g., small form factor pluggable (SFP) or quad small form factor pluggable (QSFP) modules referred to herein as SFPx, QSFPx) may include a nonvolatile memory that stores media configuration information such as media type, module capability, wavelength, etc. This media configuration information may be communicated to a host device coupled to a communication device to allow the host device to configure itself to facilitate communication between the communication device and the host device.

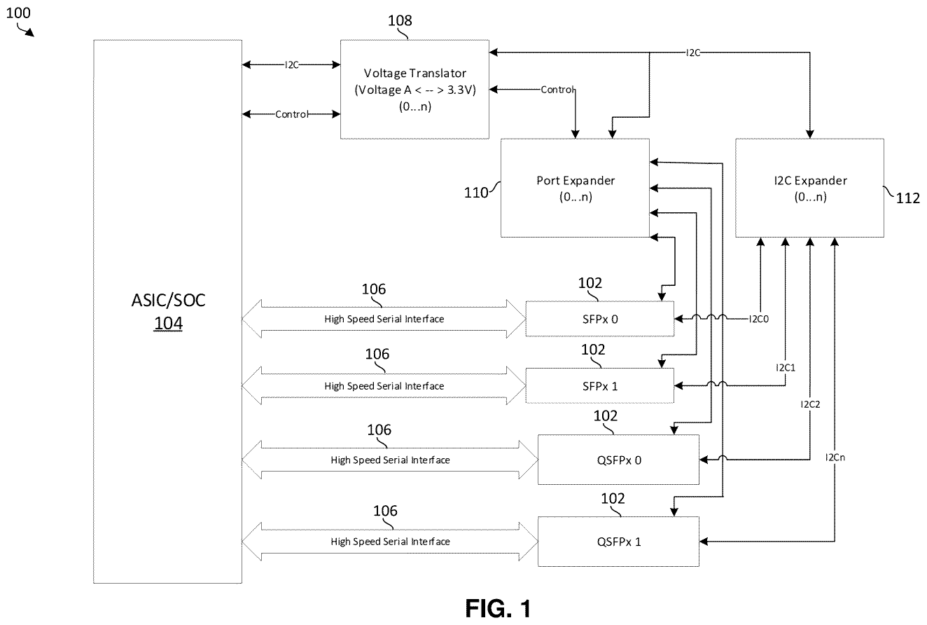

FIG. 1 illustrates connectivity of an example system 100 utilizing voltage translators, I2C expanders, and a port expander to enable SFP or QSFP connectivity. In this example, point-to-point low speed interfaces may couple to the SFPx/QSFPx connectors 102 (e.g., cages) to transport media configuration information from communication devices coupled to (e.g., plugged into) the connectors 102 to the application specific integrated circuit (ASIC)/system-on-chip (SOC) 104. For a particular connector 102, a point-to-point low speed interface (e.g., I2C) may be used to carry the media configuration information, while a high speed serial interface 106 may be used to carry mission data between the host and the communication device in a standard operating mode.

Industry multisource agreements (MSAs) for modules and standards are generally defined to support a low speed I/O voltage level of 3.3V. Future generations of products are expected to have low speed I/O voltage levels of 1.0V or lower. Due to the mismatch of supported voltage and expected voltage from the industry standards, a system 100 with such products may include a voltage translator 108 for low speed I/O connectivity. Because current industry standards specify the same I2C address for all modules (e.g., SFPx/QSFPx), system 100 also utilizes a port expander 110 and I2C expander 112 to enable communication between the ASIC/SOC 104 and multiple cages 102. In some instances, the ASIC/SOC 104 may utilize a dedicated I2C and an interrupt pin for each connector 102, which may complicate the package design and optimization efforts at design, validation, and board routing levels.

Various embodiments of the present disclosure enable communication of media configuration information from a communication device to a host device through a high speed serial interface (e.g., via in-band communication) instead of a low speed interface (e.g., a side-band interface). Thus, the high speed serial interface (rather than a low speed interface such as I2C) may be used for media detectability and associated host configuration. In some embodiments, the low speed interface (e.g., I2C) may be eliminated in whole or in part (e.g., it is not coupled to the connector that interfaces with the communication device). In some examples, this may eliminate the need for 3.3V I/O logic and/or associated voltage translators on a die. One or more of the embodiments described herein may provide technical advantages, such as simplification and lower cost of platform designs or simplified link bring up procedures.

In some examples, a module memory map for the communication device (information enabling interpretation of the media configuration information) as well as the media configuration information itself may be communicated over a high speed serial interface via Auto-Negotiation Next Pages (e.g., as defined in IEEE 802.3 CL73 or the like). In various examples, the media configuration information may be communicated in accordance with one or more of SFF-8024 Rev 4.7, SFF-8436, SFF-8636, SFF-8472, and/or Common Management Interface Specification (CMIS) module management compliance codes over high-speed serial in-band connectivity. Active media can package the media configuration information and send the media configuration information to the host through a high speed serial interface for decoding by the host to facilitate seamless link bring up.

While various embodiments are described with respect to Ethernet wireline technologies; the concepts (e.g., methods, structures, or other details) of the various embodiments may be applicable to other serial I/O protocols, such as peripheral component interconnect (PCI), PCI Express (PCIe), Universal Serial Bus (USB), Serial Attached SCSI (SAS), Serial ATA (SATA), Fibre Channel (FC), or other current or future signaling protocol.

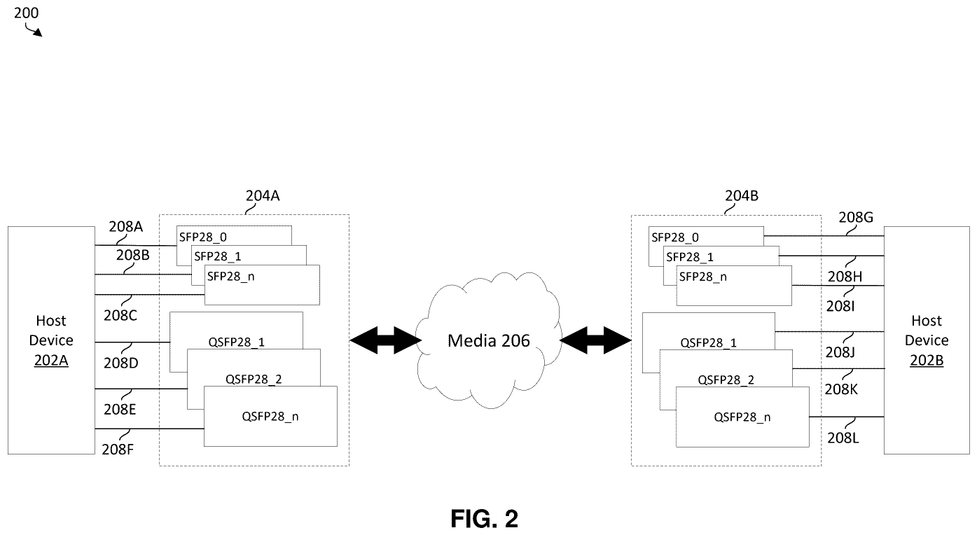

FIG. 2 illustrates connectivity of an example platform 200 in which media configuration information is communicated over at least one high speed serial interface 208 (e.g., 208A-208F). FIG. 2 depicts system connectivity between two hosts 202A, 202B, communication devices 204A, 204B, and media 206. FIG. 2 depicts host 202A coupled via high speed serial interfaces 208 to various different communication devices 204A (e.g., SFP28_0 module, SFP28_1 module, SFP28_n module, QSFP28_1 module, etc.). Thus, a computing system comprising host device 202A may comprise multiple ports (e.g., a port of high speed serial interface 208A that is to selectively couple to the SFP28_0 module, a port of high speed serial interface 208B that is to selectively couple to the SFP28_1 module, and so on).

In the example depicted, host 202A is connected to a first communication device 204A comprising module SFP28_0 via interface 208A, to a second communication device 204A comprising module SFP28_1 via interface 208B, to a third communication device 204A comprising module SFP28_n via interface 208C, to a fourth communication device comprising module QSFP28_1 via interface 208D, and so on. Similarly, host 202B is coupled via high speed serial interfaces 208 to various communication devices 204B. For example, host 202B is connected to module SFP28_0 via interface 208G, to module SFP28_1 via interface 208H, to module SFP28_n via interface 208I, to module QSFP28_1 via interface 208J, and so on.

A communication device 204A may be connected to a corresponding communication device 204B via communication media 206, which may include any number of individual communication mediums for connecting a communication device 204A to a communication device 204B. For example, a first communication medium of media 206 may connect SFP28_0 of communication devices 204A to SFP28_0 of communication devices 204B, a second communication medium of media 206 may connect SFP28_1 of communication devices 204A to SFP28_1 of communication devices 204B, and so on. The individual communication mediums may be of the same type or may be different types. Any suitable communication medium may be used to couple a first communication device 204A to a second communication device 204B, such as a passive copper cable assembly (also known as a direct attach copper cable), an active copper cable assembly, an optical medium (e.g., single-mode optical fiber (SMF), multi-mode optical fiber (MMF)), other cable, one or more conductive traces on a printed circuit board (PCB), a wireless medium, or the like. In some embodiments, the media 206 may include an Ethernet cable, such as a Cat 5, Cat 5e, Cat 6, Cat 6a, or Cat7 cable. The media 206 may be shielded or unshielded.

In various embodiments, the type of communication medium of media 206 that couples a communication device 204A to a communication device 204B may also be present on the communication devices. For example, if a copper cable connects two communication devices of 204A and 204B, the communication devices themselves may also include copper cabling or other compatible interconnect. The communication devices 204A may also include any suitable circuitry to communicate over media 206.

A high speed serial interface 208 may represent any suitable component(s) and communication medium(s) between a communication device 204 and a host device 202. For example, a high speed serial interface may include a host connector (e.g., to mechanically and electrically interface with a connector of the communication device 208) such as a port and one or more electrical and/or optical interfaces (e.g., traces on a printed circuit board, metallization on a die, waveguides, etc.). In various embodiments, the host device 202 may be part of the same system as at least a portion of the high speed serial interface 208 (e.g., on the same circuit board). The high speed serial interface 208 may communicate data sequentially (e.g., one symbol at a time) over a single communication channel (e.g., a wire or wire pair). The high speed serial interface 208 may utilize any suitable signaling scheme, such as PAM4, PAM2, NRZ, or other suitable scheme.

A host device 202 may include any suitable circuitry to communicate with a communication device 204. In one example, a host device 202 comprises an Ethernet device comprising a PHY interface that connects to a high speed serial interface 208. In some embodiments, a host device 202 may comprise or be included within an endpoint or other computing system (e.g., a system comprising a processor, a microcontroller, a field programmable gate array (FPGA), or the like) that couples to one or more communication devices 204.

Platform 200 or a portion thereof may be utilized within any suitable computing environment, such as a high performance computing environment, a datacenter, a communications service provider infrastructure (e.g., one or more portions of an Evolved Packet Core), a base station, an edge computing node, on or off premises computing environment, an in-memory computing environment, other computing environment, or combination thereof.

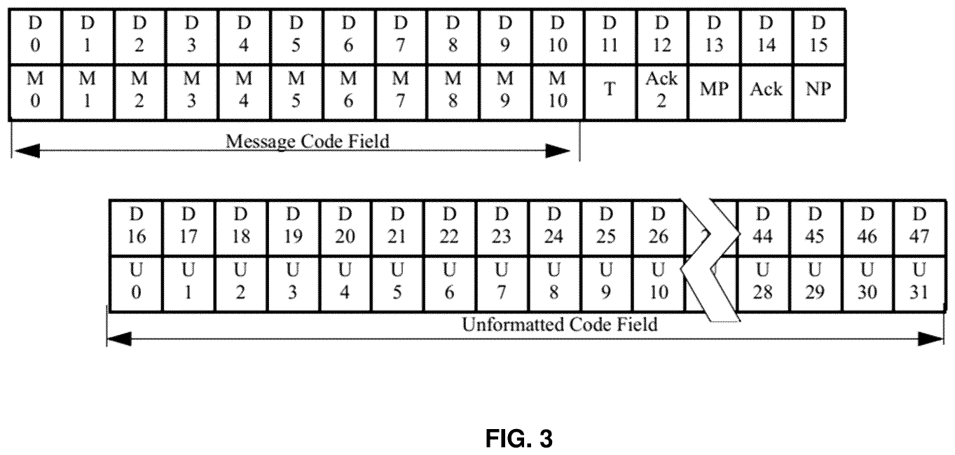

FIG. 3 illustrates a format for a Next Page defined by IEEE 802.3 CL73 that may be sent by a communication device 204 to a host device 202 to communicate media configuration information of the communication device 204, such that the host device 202 can learn about the connected media type of the communication device 204 over a high speed serial interface 208.

The Auto-Negotiation and Next Page exchange protocol specified in IEEE 802.3 CL73 was originally defined for Ethernet PHYs operating over a backplane and for use with Ethernet PHYs operating over a passive copper cable assembly. This protocol is typically used to exchange information (e.g., data rate) between connected end points across a channel. The protocol may also be used to exchange proprietary information related to the device. This protocol is point-to-point, which makes it suitable for exchanging media configuration information between connected end points (e.g., a communication device 204 and a host device 202).

In the Auto-Negotiation process defined by the IEEE standard, the Next Page exchange occurs after the exchange of the base link codewords (e.g., transmitted nonce field, echoed nonce field, technology ability field, effect capability field, etc.) when an endpoint on either end of the link sets the Next Page bit to a logical one (this indicates that the endpoint has at least one Next Page to exchange).

FIG. 3 depicts the format for a Next Page. As depicted, the Next Page contains two message fields: a message code field and an unformatted code field as well as other bits (D11-D15, which may be referred to as a flags field). The message code field specifies how the unformatted code field is to be interpreted.

Various embodiments of the present disclosure utilize a new value for the message code field for a Next Page that carries media configuration information. For example, a Next Page may include a message code with a value of 15 indicating that the Next Page includes media configuration information. For example, the message code field in such a Next Page may be defined as follows (where bits M0-M10 are sent as D0-D10 of the Next Page as illustrated in FIG. 3):

| | | | | | | | | | | | | Message |
|---|---|---|---|---|---|---|---|---|---|---|---|---|
| Mes- | | | | | | | | | | | | Code |
| sage | | | | | | | | | | | | Descrip- |
| Code | M0 | M1 | M2 | M3 | M4 | M5 | M6 | M7 | M8 | M9 | M10 | tion |
| 15 | 0 | 0 | 0 | 0 | 0 | 0 | 0 | 1 | 1 | 1 | 1 | Connected |
| | | | | | | | | | | | | Media and |
| | | | | | | | | | | | | Supported |
| | | | | | | | | | | | | MSA |

In other embodiments, any other suitable message code value that does not conflict with message code values that are used for other purposes may be used to indicate that the Next Page includes media configuration information.

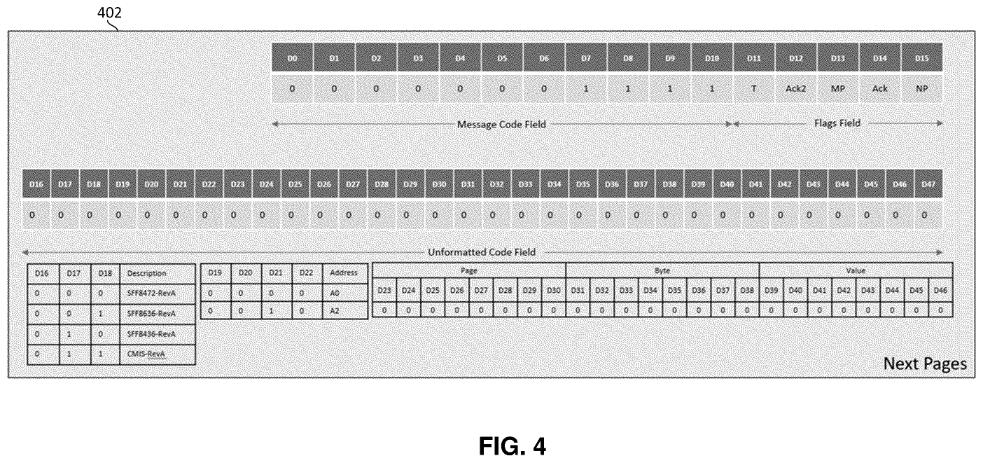

FIG. 4 illustrates an example encoding 402 of Next Pages utilizing the new value for the message code field. In the encoding depicted, D0 through D10 of a Next Page includes the new value of 15 in the message code field (e.g., D7-D10 are each set to 1 while D0-D6 are set to 0).

In the depicted embodiment, D16:D18 of the unformatted code field encodes a type of the supported MSA (e.g., a management interface specification). These bits provide an indication of a mapping of a memory (e.g., EEPROM or other non-volatile memory) of the communication device 204. For example, SFF-8024 specifies such mappings for SFF-8472, SFF-8636, SFF-8436, and CMIS (wherein a particular location in memory is mapped to a table that specifies a plurality of values and parameter values corresponding to the plurality of values). In some embodiments, the bits indicating the memory mapping (also referred to as a module memory map) are communicated in every Next Page that includes media configuration information provided by the communication device 204 to the host device 202 to facilitate module memory map interpretation and readability (although embodiments are not limited thereto). The encoding 402 shows example values for various supported MSAs. For example, for D16-D18, a value of 000 indicates SFF8472-RevA, a value of 001 indicates SFF8636-RevA, a value of 010 indicates SFF8436-RevA, and a value of 011 indicates CMIS-RevA. In other embodiments, other bits of the unformatted code field could be used to indicate the module memory map and/or the values used to indicate particular module memory maps may be different.

In the depicted embodiment, D19:D22 of the unformatted code field encodes an address of the storage media, D23:D30 of the unformatted code field encodes a page of the storage media, D31:D38 of the unformatted code field encodes a byte of the storage media, and D39:D46 of the unformatted code field encodes the value at the memory location specified by the address, page, and/or byte of the memory of the communication device that sends the Next Page.

In operation, a communication device 204 may send any suitable number of Next Pages, with individual Next Pages specifying a different combination of address, page, and byte, and including the corresponding value in the memory of the communication device at the location indicated by that address, page, and/or byte.

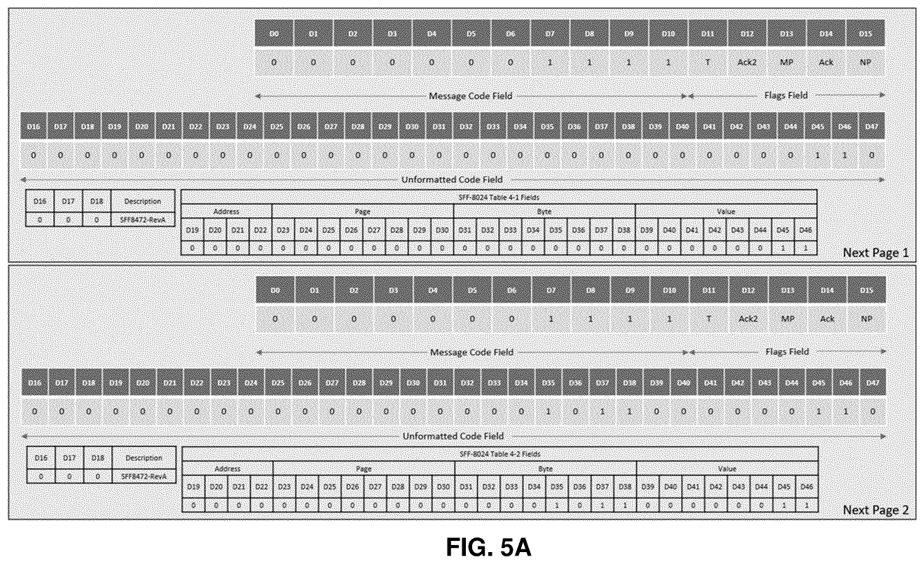

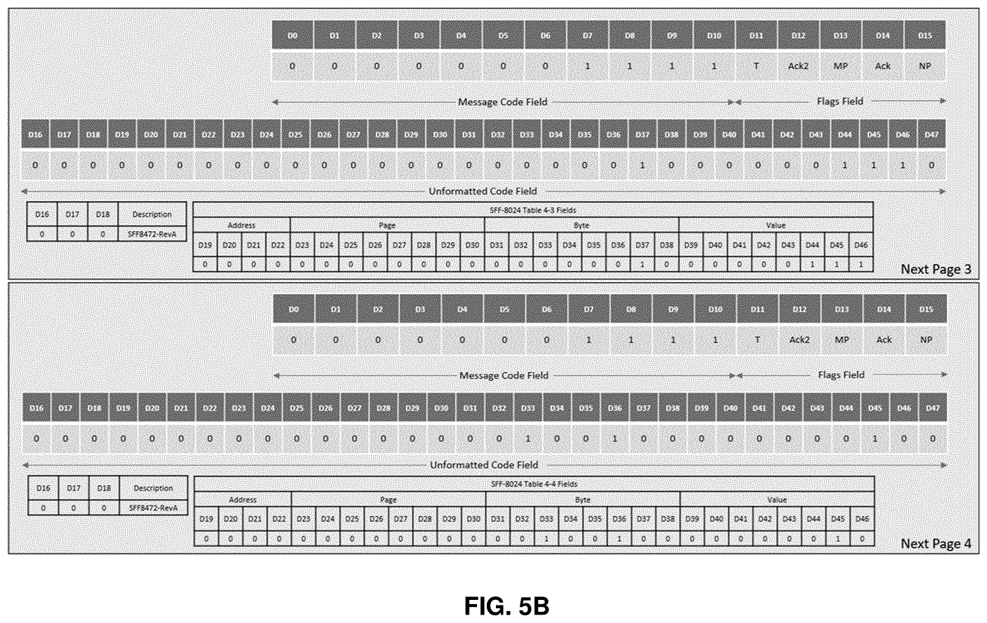

FIGS. 5A-5B illustrate example Next Page encodings that may be sent by a communication device comprising an SFPx module complying with MSA SFF8472, such as an 25GBASE-SR, LC, SFP28 module. In these Next Pages, the Address, Byte, and Data fields are populated according to MSA SFF-8024-Rev 4.7. The media configuration information included in the extended Next Pages depicted in FIGS. 5A-5B is described below.

Next Page 1 utilizes the value of 000 in D16-D18 of the unformatted code field to specify SFF-8472-RevA. Next Page 1 also includes a memory location (Address 0, Page 0, and Byte 0) and corresponding value (03h in this example). Per the module memory map corresponding to SFF-8472, the memory location is mapped to Table 4-1 of Transceiver Identifier Values in SFF-8024. A Transceiver Identifier Value provides a description of the module (e.g., a type of the module). In this instance, the value of 03h corresponds to SFP/SFP+/SFP28 and later with a SFF-8472 management interface. In various embodiments, any of the modules (e.g., SFPx, QSFPx, OSFP, etc.) of Table 4-1 of SFF-8024 or other suitable modules (e.g., a mmWave module) may be specified by including the corresponding parameter value (e.g., in a Next Page). In some embodiments, the module specified may indicate a form factor of the module.

Next Page 2 again utilizes the value of 000 in D16-D18 of the unformatted code field to specify SFF-8472-RevA. Next Page 2 also includes a memory location (Address 0, Page, 0, and Byte 11) and corresponding value (03h in this example). Per the module memory map, the memory location is mapped to Table 4-2 of Encoding Values in SFF-8024. An Encoding Value indicates a serial encoding mechanism to be used by the communication device. In this instance, the value of 03h corresponds to NRZ encoding. In various embodiments, any of the encoding mechanisms (e.g., 8B/10B, 4B/5B, Manchester, SONET scrambled, 64B/66B, PAM4, etc.) of Table 4-2 of SFF-8024 or other suitable encoding mechanisms may be specified by including the corresponding parameter value (e.g., in a Next Page).

Next Page 3 again utilizes the value of 000 in D16-D18 of the unformatted code field to specify SFF-8472-RevA. Next Page 3 also includes a memory location (Address 0, Page, 0, and Byte 2) and corresponding value (07h in this example). Per the module memory map, the memory location is mapped to Table 4-3 of Connector Types in SFF-8024. In this instance, the value of 07h corresponds to a Lucent Connector (LC). In various embodiments, any of the connector types (e.g., Fibre Channel Style, optical pigtail, copper pigtail, RJ45, etc.) of Table 4-of SFF-8024 3 or other suitable connector types may be specified by including the corresponding parameter value (e.g., in a Next Page).

Next Page 4 again utilizes the value of 000 in D16-D18 of the unformatted code field to specify SFF-8472-RevA. Next Page 4 also includes a memory location (address 0, page, 0, and byte 36) and corresponding value (02h in this example). Per the module memory map, the memory location is mapped to Table 4-4 of Extended Specification Compliance Codes in SFF-8024. An Extended Specification Compliance Code may identify an electronic or optical interface (e.g., one that is not included in the SFF-8472 Optical and Cable Variants Specification Compliance or SFF-8636 Specification Compliance Codes). In this instance, the value of 02h corresponds to 100GBASE-SR4 or 25GBASE-SR (as indicated above, the next pages of FIGS. 5A-5B were for a 25GBASE-SR module). In various embodiments, any of the module capabilities (e.g., 100GBASE-ER4, 25GBASE-LR, 5GBASE-T, 100G SWDM4, etc.) of Table 4-4 of SFF-8024 or other suitable module capabilities may be specified by including the corresponding parameter value (e.g., in a Next Page). In some embodiments, the module capabilities may indicate a data rate or a wavelength of communication supported by the communication device (e.g., 204) and connected media (e.g., 206).

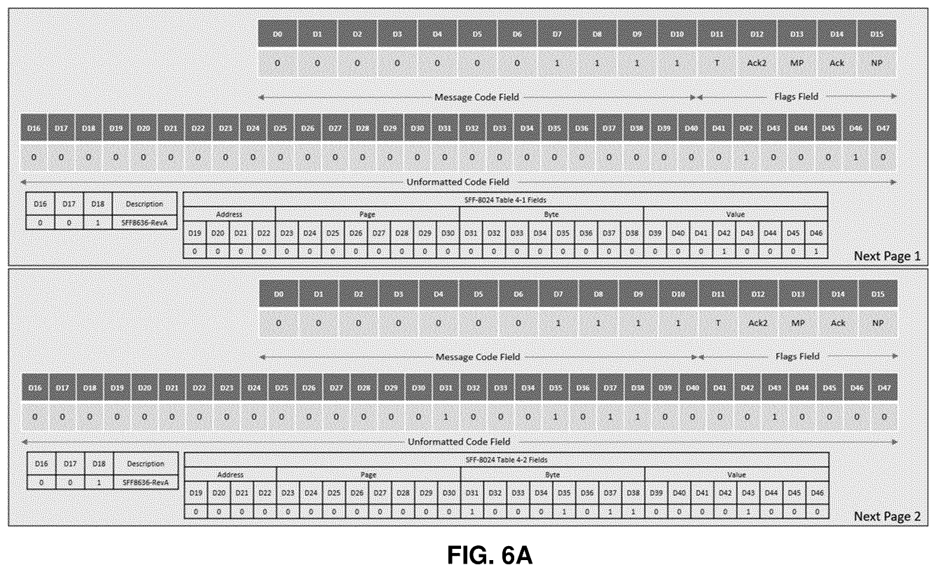

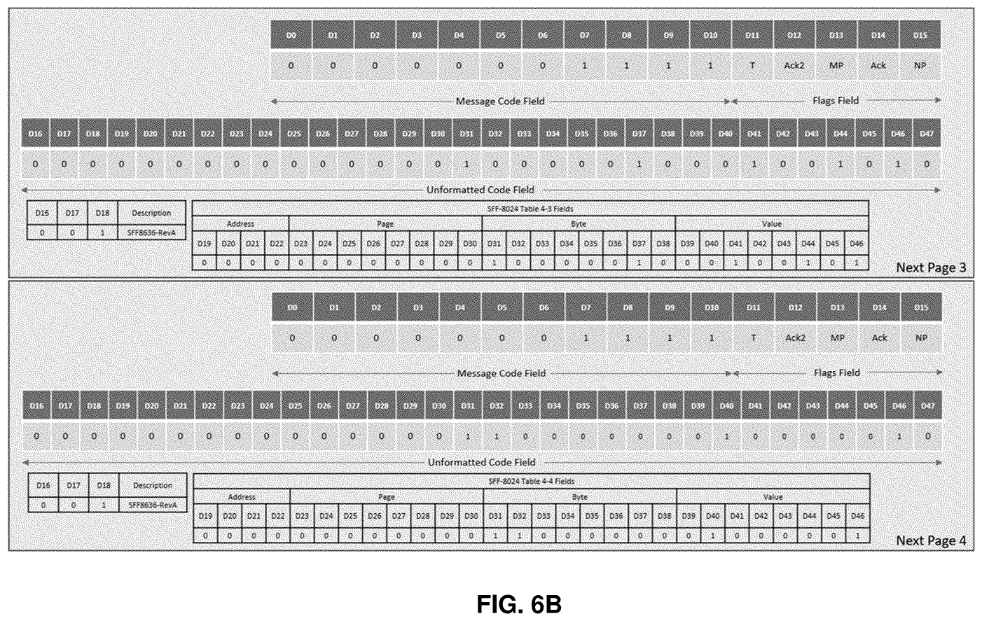

FIGS. 6A-6B illustrate example Next Page encodings for a communication device comprising an SFF-8636 100GBASE-SR2 QSFP28 module. As an example, for a communication device with a 100GBASE-SR2 QSFP28 optical module that supports PAM4 encoding over CS connector type, the Next Page message code and unformatted code fields of Next Pages sent by the communication device to a host device can be encoded as shown in FIGS. 6A-6B. Again, the Address, Byte, and Data fields are populated according to MSA SFF-8024-Rev 4.7.

Next Page 1 utilizes the value of 001 in D16-D18 of the unformatted code field to specify SFF8636-RevA. Next Page 1 also includes a memory location (Address 0, Page, 0, and Byte 0) and corresponding value (11h in this example). Per the module memory map corresponding to SFF8636, the memory location is mapped to Table 4-1 of Transceiver Identifier Values in SFF-8024. In this instance, the value of 11h corresponds to QSFP28 or later with SFF-8636 management interface management interface.

Next Page 2 again utilizes the value of 001 in D16-D18 of the unformatted code field to specify SFF8636-RevA. Next Page 2 also includes a memory location (Address 0, Page, 0, and Byte 139) and corresponding value (08h in this example). Per the module memory map corresponding to SFF8636, the memory location is mapped to Table 4-2 of Encoding Values. In this instance, the value of 08h corresponds to PAM4 encoding.

Next Page 3 again utilizes the value of 001 in D16-D18 of the unformatted code field to specify SFF8636-RevA. Next Page 3 also includes a memory location (Address 0, Page, 0, and Byte 130) and corresponding value (25h in this example). Per the module memory map corresponding to SFF8636, the memory location is mapped to Table 4-3 of Connector Types. In this instance, the value of 25h corresponds to a CS optical connector.

Next Page 4 again utilizes the value of 001 in D16-D18 of the unformatted code field to specify SFF8636-RevA. Next Page 4 also includes a memory location (Address 0, Page, 0, and Byte 192) and corresponding value (41h in this example). Per the module memory map corresponding to SFF8636, the memory location is mapped to Table 4-4 of Extended Specification Compliance Codes in SFF-8024. In this instance, the value of 41h corresponds to 50GBASE-SR, 100GBASE-SR2, or 200GBASE-SR4 (as indicated above, the next pages of FIGS. 6A-6B are sent by a 100GBASE-SR2 module).

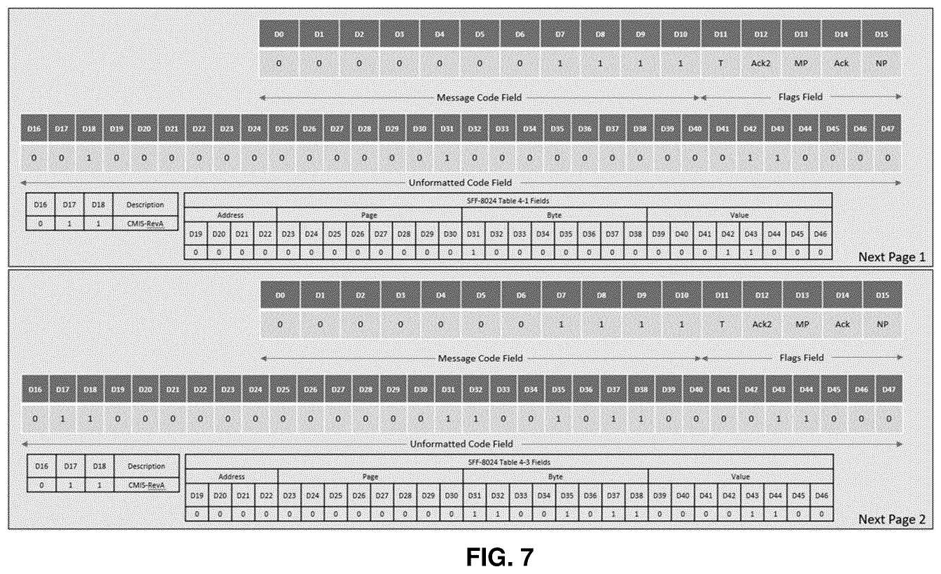

FIG. 7 illustrates example next page encodings for a 400GBASE-DR4 QSFP-DD module with a CMIS memory map.

Next Page 1 utilizes the value of 011 in D16-D18 of the unformatted code field to specify CMIS-RevA. Next Page 1 also includes a memory location (Address 0, Page, 0, and Byte 128) and corresponding value (18h in this example). Per the module memory map corresponding to CMIS, the memory location is mapped to Table 4-1 of Transceiver Identifier Values in SFF-8024. In this instance, the value of 18h corresponds to QSFP-DD Double Density 8X Pluggable Transceiver (INF-8628).

Next Page 2 again utilizes the value of 011 in D16-D18 of the unformatted code field to specify CMIS-RevA. Next Page 2 also includes a memory location (Address 0, Page, 0, and Byte 203) and corresponding value (0Ch in this example). Per the module memory map corresponding to CMIS, the memory location is mapped to Table 4-3 of Connector Types. In this instance, the value of 0Ch corresponds to a Multifiber Parallel Optic (MPO) 1×12.

In any of these examples or in other contemplated Next Page encodings for any suitable module type, additional and/or other media configuration information may be encoded (e.g., depending on module capabilities on host and line side). The information to be provided in an in-band message (e.g., across the same interface that is used to communicate mission data during a standard operational mode) for module detection may vary based on the type of the media and channel.

Various additional examples of media configuration information that may be included in a Next Page encoding include power class (e.g., indicating an amount of power the communication device will consume), type of media coupled to the communication device (e.g., optical, passive copper cable, active copper cable, etc.), active alarms (e.g., irregular conditions detected by the module such as heat threshold crossed, internal error, or signal quality low, etc.), length of the communication device and/or media attached to the communication device, supported data rate, other module capabilities, wavelength, etc.

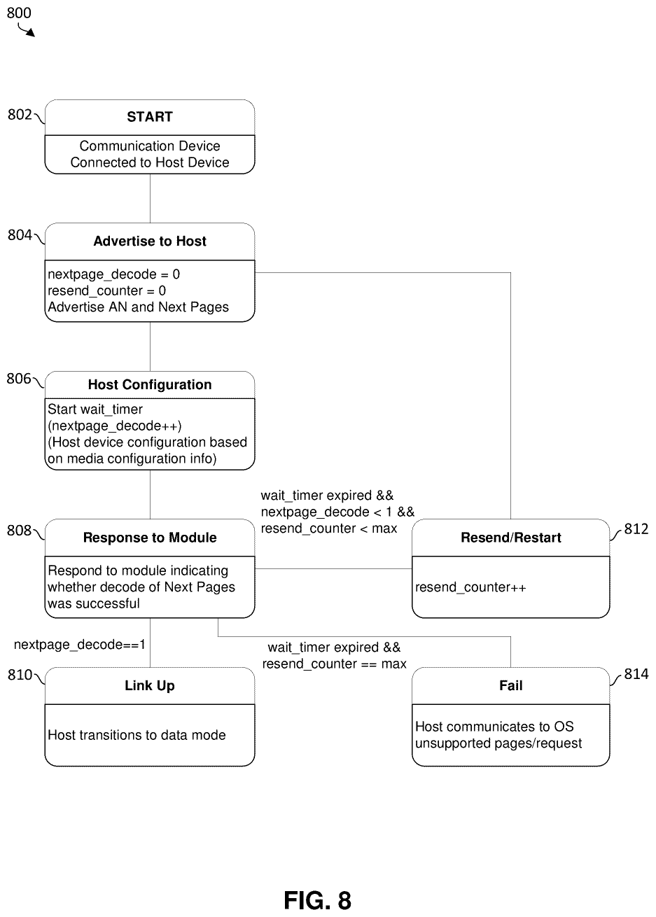

FIG. 8 illustrates a flow 800 for communicating media configuration information over a high speed serial interface. The flow begins at 802 as a communication device is connected to a host device. For example, a connector of the communication device may be inserted into or otherwise connected to a connector (e.g., a cage) of a platform comprising the host device.

At 804, the host device initializes a nextpage_decode variable and a resend_counter. At 804, the communication device begins advertising auto-negotiation (AN) base pages (e.g., base link codewords) and Next Pages, e.g., as defined by IEEE 802.3 CL73 to the host device.

At 806, the host device starts a wait_timer and attempts to decode the Next Pages. If the host device is able to successfully decode all of the received Next Pages before the wait_timer expires, then the host device increments the nextpage_decode variable and performs host device configuration. If the host device is unable to decode one or more of the Next Pages then the nextpage_decode variable is not incremented. At 806, upon successful decode of one or more Next Pages, the host device performs configuration based on the media configuration information sent in the Next Pages. For example, the host device may configure a local subsystem based on the media configuration information. This may include, for example, configuring a serializer/deserializer (SERDES) of the host device. For example, the frequency of one or more clocks of the host device may be set based on the media configuration information (e.g., based on a data rate supported by the communication device). As another example, one or more equalization filters may be set based on the media configuration information (e.g., to account for characteristics of the channel between the host device and the communication device and/or characteristics of the media (e.g., 206) connected to the communication device).

At 808, the host device may respond to the communication device with an indication of whether the Next Pages were successfully decoded and then may transition to a link up state at 810 if the decode was successful (e.g., if nextpage_decode is equal to 1). The link up state may correspond to a standard operating mode in which the host device receives normal mission data (e.g., from another computing platform through the communication device) over the high speed serial interface (the same interface that was used to send the Next Pages), while 804, 806, and 808 may correspond to communications occurring in a non-standard operating mode in which the host is configuring the serial interface prior to sending and receiving data over the link in the standard operating mode.

Going back to 808, if the wait_timer has expired and the nextpage_decode variable has not been incremented, then the host device increments the resend_counter and requests resending of the Next Pages by the communication device at 812. The flow may then move to 804 where the Next Pages are resent. In some embodiments, the host device may proactively request retransmission of one or more Next Pages and the communication device may resend the one or more Next Pages (e.g., rather than waiting for a timer to expire).

At 808, if the wait_timer has expired and the resend_counter has reached its maximum value, then the flow proceeds to 814, where the host device communicates the failure to decode the pages to an operating system, unified extensible firmware interface, or the like. This communication may be sent, e.g., when the host device is unable to decode the Next Pages or unsupported Next Pages are sent with a different message code.

A trigger for generating discovery or diagnostic information on the status of the link may be implementation specific and may happen during normal operation or in response to a failure or alarm. In some embodiments, when various embodiments are used in a data center or the like, a management controller can extract information about the link status to monitor the link for irregularities.

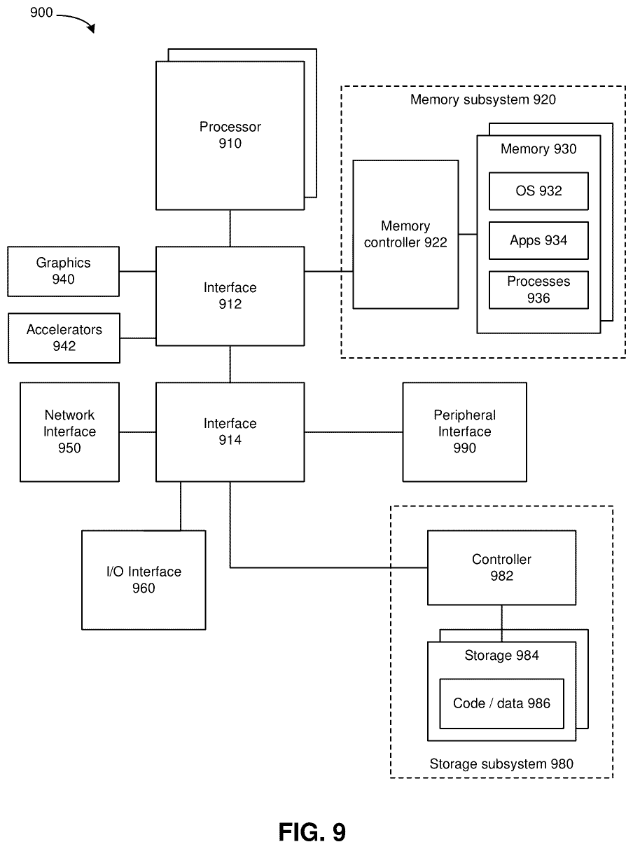

FIG. 9 depicts an example computing system that may be utilized in various embodiments. For example, system 900 may include a connector that interfaces with a communication device that utilizes Next Pages to communicate media configuration information as described herein. As another example, system 900 may include a host device that may be coupled to such a communication device.

System 900 includes processor 910, which provides processing, operation management, and execution of instructions for system 900. Processor 910 can include any type of microprocessor, central processing unit (CPU), graphics processing unit (GPU), processing core, or other processing hardware to provide processing for system 900, or a combination of processors. Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 900 includes interface 912 coupled to processor 910, which can represent a higher speed interface or a high throughput interface for system components that needs higher bandwidth connections, such as memory subsystem 920 or graphics interface components 940, or accelerators 942. Interface 912 represents an interface circuit, which can be a standalone component or integrated onto a processor die. Where present, graphics interface 940 interfaces to graphics components for providing a visual display to a user of system 900. In one example, graphics interface 940 can drive a high definition (HD) display that provides an output to a user. In one example, graphics interface 940 generates a display based on data stored in memory 930 or based on operations executed by processor 910 or both. In one example, graphics interface 940 generates a display based on data stored in memory 930 or based on operations executed by processor 910 or both.

Accelerators 942 can be a fixed function offload engine that can be accessed or used by a processor 910. For example, an accelerator among accelerators 942 can provide compression (DC) capability, cryptography services such as public key encryption (PKE), cipher, hash/authentication capabilities, decryption, or other capabilities or services. In some embodiments, in addition or alternatively, an accelerator among accelerators 942 provides field select controller capabilities as described herein. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 942 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 920 represents the main memory of system 900 and provides storage for code to be executed by processor 910, or data values to be used in executing a routine. Memory subsystem 920 can include one or more memory devices 930 such as read-only memory (ROM), flash memory, one or more varieties of random access memory (RAM) such as DRAM, or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can transmit data to a device that is in the same data center or rack or a remote device, which can include sending data stored in memory. Network interface 950 can receive data from a remote device, which can include storing received data into memory. Various embodiments can be used in connection with network interface 950, processor 910, and memory subsystem 920.

In one example, system 900 includes one or more input/output (I/O) interface(s) 960. I/O interface 960 can include one or more interface components through which a user interacts with system 900 (e.g., audio, alphanumeric, tactile/touch, or other interfacing). Peripheral interface 970 can include any hardware interface not specifically mentioned above. Peripherals refer generally to devices that connect dependently to system 900. A dependent connection is one where system 900 provides the software platform or hardware platform or both on which operation executes, and with which a user interacts.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage 984 holds code or instructions and data 986 in a persistent state (e.g., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (e.g., the value or state of the data is indeterminate if power is interrupted to system 900). In one example, storage subsystem 980 includes controller 982 to interface with storage 984. In one example controller 982 is a physical part of interface 914 or processor 910 or can include circuits or logic in both processor 910 and interface 914.

A power source (not depicted) provides power to the components of system 900. More specifically, power source typically interfaces to one or multiple power supplies in system 900 to provide power to the components of system 900. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

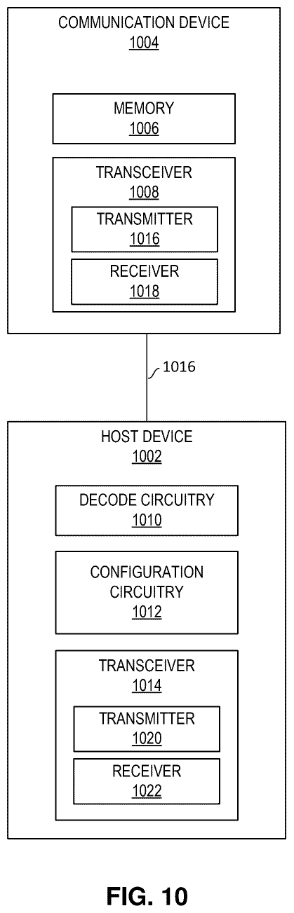

FIG. 10 illustrates an example host device 1002 and an example communication device 1004. The communication device 1004 includes a memory 1006 and a transceiver 1008 (comprising transmitter 1016 and receiver 1018 to communicate over interface 1016) among other logic. The memory 1006 may store media configuration information of the communication device 1004. In various embodiments, the memory is non-volatile. Non-volatile memory is a storage medium that does not require power to maintain the state of data stored by the medium. Nonlimiting examples of non-volatile memory may include any or a combination of: solid state memory (such as planar or 3D NAND flash memory or NOR flash memory), 3D crosspoint memory, byte addressable nonvolatile memory devices, electrically erasable programmable read-only memory (EEPROM), or other non-volatile memory devices.

The transmitter 1016 may communicate Next Pages comprising media configuration information to the host device during a non-standard operating mode to allow the host device to configure itself based on the media configuration information in preparation to exchange data with the communication device 1004 during a standard operating mode. The non-standard operating mode may represent an operating mode in which configuration information is exchanged between the communication device 1004 and the host device 1002 and the communication device 1004 and the host device 1002 configure themselves based on the configuration information prior to a transition to a standard operating mode in which mission data is exchanged during normal operation.

In various examples, the communication device 1004 may comprise an active cable, a passive cable, a pluggable optical transceiver, a pluggable 1000 base T module, or other suitable communication device. In some embodiments, the communication device 1004 may have any suitable form factor defined by industry standards, such as SFP+, SFP-DD, DSFP, QSFP, QSFP-DD, OSFP, COBO, etc.

The host device 1002 may comprise decode circuitry 1010 to decode a plurality of Next Pages including media configuration information received by receiver 1022 from the communication device 1004. Host device 1002 may also include configuration circuitry 1012 to configure circuitry of the host device 1002 based on the media configuration information included in the Next Pages (e.g., to optimize the transceiver 1014 for communication to be performed during a standard operating mode in which mission data is communicated over the interface 1016 between the communication device 1004 and the host device 1002). In various embodiments, at least a portion of the Next Pages and at least a portion of the mission data may be transferred over the same wire or wires of interface 1016.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disk may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

In various embodiments, a medium storing a representation of the design may be provided to a manufacturing system (e.g., a semiconductor manufacturing system capable of manufacturing an integrated circuit and/or related components). The design representation may instruct the system to manufacture a device capable of performing any combination of the functions described above. For example, the design representation may instruct the system regarding which components to manufacture, how the components should be coupled together, where the components should be placed on the device, and/or regarding other suitable specifications regarding the device to be manufactured.

A module as used herein or as depicted in the FIGs. refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Logic may be used to implement any of the flows described or functionality of the various systems or components described herein. “Logic” may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a storage device containing instructions, combinations of logic devices (e.g., as would be found on a printed circuit board), or other suitable hardware and/or software. Logic may include one or more gates or other circuit components. In some embodiments, logic may also be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in storage devices.

Use of the phrase ‘to’ or ‘configured to,’ in one embodiment, refers to arranging, putting together, manufacturing, offering to sell, importing, and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g., reset, while an updated value potentially includes a low logical value, e.g., set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A machine-accessible/readable medium includes any mechanism that provides (e.g., stores and/or transmits) information in a form readable by a machine, such as a computer or electronic system. For example, a machine-accessible medium includes random-access memory (RAM), such as static RAM (SRAM) or dynamic RAM (DRAM); ROM; magnetic or optical storage medium; flash storage devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

Various examples of the embodiments described herein are as follows:

Example 1 includes a host device comprising first circuitry to receive one or more packets sent by a communication device over a serial communication interface between the communication device and the host device, wherein the one or more packets comprise media configuration information stored in a memory of the communication device and an indication of a mapping of the memory of the communication device; and second circuitry to transmit data packets over the serial communication interface after the host device has been configured based on the media configuration information.

Example 2 includes the subject matter of Example 1, and wherein the media configuration information and the indication of the mapping of the memory are included within one or more Auto-Negotiation Next Pages.

Example 3 includes the subject matter of any of Examples 1 and 2, and wherein the one or more Auto-Negotiation Next Pages include a message code field value identifying the Auto-Negotiation Next Pages as including media configuration information.

Example 4 includes the subject matter of any of Examples 1-3, and wherein configuring the host device based on the media configuration information comprises setting a frequency of at least one clock of the host device.

Example 5 includes the subject matter of any of Examples 1-4, and wherein configuring the host device based on the media configuration information comprises setting an equalization filter of the host device.

Example 6 includes the subject matter of any of Examples 1-5, and wherein a packet of the one or more packets comprises location information of the memory and media configuration information stored at that location in the memory.

Example 7 includes the subject matter of any of Examples 1-6, and wherein the location information comprises an indication of a byte of the memory.

Example 8 includes the subject matter of any of Examples 1-7, and wherein the media configuration information comprises a transceiver identifier value.

Example 9 includes the subject matter of any of Examples 1-8, and wherein the media configuration information comprises an indication of a type of serial data encoding to be used by the communication device to send data packets over the serial communication interface.

Example 10 includes the subject matter of any of Examples 1-9, and wherein the media configuration information comprises an indication of a connector type of the communication device.

Example 11 includes the subject matter of any of Examples 1-10, and wherein the media configuration information comprises an identification of an electronic or optical interface of the communication device.

Example 12 includes the subject matter of any of Examples 1-11, and further including a processor.

Example 13 includes the subject matter of any of Examples 1-12, and further comprising one or more of a battery communicatively coupled to the processor, a display communicatively coupled to the processor, or a network interface communicatively coupled to the processor.

Example 14 includes a communication device comprising a memory comprising media configuration information; and circuitry to send, during a non-standard operating mode, one or more packets over a serial communication interface between the communication device and a host device, wherein the one or more packets comprise media configuration information stored in the memory and an indication of a mapping of the memory; and send, during a standard operating mode, data packets over the serial communication interface.

Example 15 includes the subject matter of Example 14, and wherein the media configuration information and the indication of the mapping of the memory are included within one or more Auto-Negotiation Next Pages.

Example 16 includes the subject matter of any of Examples 14 and 15, and wherein the memory comprises an electrically erasable programmable read-only memory (EEPROM).

Example 17 includes the subject matter of any of Examples 14-16, and wherein the media configuration information comprises a power class of the communication device.

Example 18 includes the subject matter of any of Examples 14-17, and wherein the media configuration information comprises an alarm associated with the communication device.

Example 19 includes the subject matter of any of Examples 14-18, and wherein the one or more Auto-Negotiation Next Pages include a message code field value identifying the Auto-Negotiation Next Pages as including media configuration information.

Example 20 includes the subject matter of any of Examples 14-19, and wherein configuring the host device based on the media configuration information comprises setting a frequency of at least one clock of the host device.

Example 21 includes the subject matter of any of Examples 14-20, and wherein configuring the host device based on the media configuration information comprises setting an equalization filter of the host device.

Example 22 includes the subject matter of any of Examples 14-21, and wherein a packet of the one or more packets comprises location information of the memory and media configuration information stored at that location in the memory.

Example 23 includes the subject matter of any of Examples 14-22, and wherein the location information comprises an indication of a byte of the memory.

Example 24 includes the subject matter of any of Examples 14-23, and wherein the media configuration information comprises a transceiver identifier value.

Example 25 includes the subject matter of any of Examples 14-24, and wherein the media configuration information comprises an indication of a type of serial data encoding to be used by the communication device to send data packets over the serial communication interface.

Example 26 includes the subject matter of any of Examples 14-25, and wherein the media configuration information comprises an indication of a connector type of the communication device.

Example 27 includes the subject matter of any of Examples 14-26, and wherein the media configuration information comprises an identification of an electronic or optical interface of the communication device.

Example 28 includes a method comprising receiving, by a host device from a communication device during a non-standard operating mode, one or more packets comprising media configuration information of the communication device over a serial communication interface; and receiving, by the host device from the communication device during a standard operating mode, data packets over the serial communication interface.

Example 29 includes the subject matter of Example 28, and wherein the media configuration information is included within one or more Auto-Negotiation Next Pages.

Example 30 includes the subject matter of any of Examples 28 and 29, and wherein the one or more Auto-Negotiation Next Pages include a message code field value identifying the Auto-Negotiation Next Pages as including media configuration information.

Example 31 includes the subject matter of any of Examples 28-30, and further including configuring the host device based on the media configuration information.

Example 32 includes the subject matter of any of Examples 28-31, and wherein configuring the host device based on the media configuration information comprises setting a frequency of at least one clock of the host device.

Example 33 includes the subject matter of any of Examples 28-32, and wherein configuring the host device based on the media configuration information comprises setting an equalization filter of the host device.

Example 34 includes the subject matter of any of Examples 28-33, and wherein a packet of the one or more packets comprises location information of the memory and media configuration information stored at that location in the memory.

Example 35 includes the subject matter of any of Examples 28-34, and wherein the location information comprises an indication of a byte of the memory.

Example 36 includes the subject matter of any of Examples 28-35, and wherein the media configuration information comprises a transceiver identifier value.

Example 37 includes the subject matter of any of Examples 28-36, and wherein the media configuration information comprises an indication of a type of serial data encoding to be used by the communication device to send data packets over the serial communication interface.

Example 38 includes the subject matter of any of Examples 28-37, and wherein the media configuration information comprises an indication of a connector type of the communication device.

Example 39 includes the subject matter of any of Examples 28-38, and wherein the media configuration information comprises an identification of an electronic or optical interface of the communication device.

Example 40 includes a system comprising first means to receive one or more packets sent by a communication device over a serial communication interface between the communication device and the host device, wherein the one or more packets comprise media configuration information stored in a memory of the communication device and an indication of a mapping of the memory of the communication device; and second means to transmit data packets over the serial communication interface after the host device has been configured based on the media configuration information.

Example 41 includes the subject matter of Example 40, and wherein the media configuration information and the indication of the mapping of the memory are included within one or more Auto-Negotiation Next Pages.

Example 42 includes the subject matter of any of Examples 40 and 41, and wherein the one or more Auto-Negotiation Next Pages include a message code field value identifying the Auto-Negotiation Next Pages as including media configuration information.

Example 43 includes the subject matter of any of Examples 40-42, and wherein configuring the host device based on the media configuration information comprises setting a frequency of at least one clock of the host device.

Example 44 includes the subject matter of any of Examples 40-43, and wherein configuring the host device based on the media configuration information comprises setting an equalization filter of the host device.

Example 45 includes the subject matter of any of Examples 40-44, and wherein a packet of the one or more packets comprises location information of the memory and media configuration information stored at that location in the memory.

Example 46 includes the subject matter of any of Examples 40-45, and wherein the location information comprises an indication of a byte of the memory.

Example 47 includes the subject matter of any of Examples 40-46, and wherein the media configuration information comprises a transceiver identifier value.

Example 48 includes the subject matter of any of Examples 40-47, and wherein the media configuration information comprises an indication of a type of serial data encoding to be used by the communication device to send data packets over the serial communication interface.

Example 49 includes the subject matter of any of Examples 40-48, and wherein the media configuration information comprises an indication of a connector type of the communication device.

Example 50 includes the subject matter of any of Examples 40-49, and wherein the media configuration information comprises an identification of an electronic or optical interface of the communication device.

Example 51 includes the subject matter of any of Examples 40-50, and further including processing means.

Example 52 includes the subject matter of any of Examples 40-51, and further including one or more of a battery communicatively coupled to the processing means, a display communicatively coupled to the processing means, or a network interface communicatively coupled to the processing means.

1-20. (canceled)

21. A host device comprising:
first circuitry to receive one or more packets sent by a communication device over a serial communication interface between the communication device and the host device, wherein the one or more packets comprise media configuration information stored in a memory of the communication device and an indication of a mapping of the memory of the communication device; and
second circuitry to transmit data packets over the serial communication interface after the host device has been configured based on the media configuration information.

22. The host device of claim 21, wherein the media configuration information and the indication of the mapping of the memory are included within one or more Auto-Negotiation Next Pages.

23. The host device of claim 22, wherein the one or more Auto-Negotiation Next Pages include a message code field value identifying the Auto-Negotiation Next Pages as including media configuration information.

24. The host device of claim 21, wherein configuring the host device based on the media configuration information comprises setting a frequency of at least one clock of the host device.

25. The host device of claim 21, wherein configuring the host device based on the media configuration information comprises setting an equalization filter of the host device.

26. The host device of claim 21, wherein a packet of the one or more packets comprises location information of the memory and media configuration information stored at that location in the memory.

27. The host device of claim 26, wherein the location information comprises an indication of a byte of the memory.

28. The host device of claim 21, wherein the media configuration information comprises a transceiver identifier value.

29. The host device of claim 21, wherein the media configuration information comprises an indication of a type of serial data encoding to be used by the communication device to send data packets over the serial communication interface.

30. The host device of claim 21, wherein the media configuration information comprises an indication of a connector type of the communication device.

31. The host device of claim 21, wherein the media configuration information comprises an identification of an electronic or optical interface of the communication device.

32. The host device of claim 21, further comprising a processor.

33. The host device of claim 32, further comprising one or more of: a battery communicatively coupled to the processor, a display communicatively coupled to the processor, or a network interface communicatively coupled to the processor.

34. A communication device comprising:
a memory comprising media configuration information; and
circuitry to:
send, during a non-standard operating mode, one or more packets over a serial communication interface between the communication device and a host device, wherein the one or more packets comprise media configuration information stored in the memory and an indication of a mapping of the memory; and
send, during a standard operating mode, data packets over the serial communication interface.

35. The communication device of claim 34, wherein the media configuration information and the indication of the mapping of the memory are included within one or more Auto-Negotiation Next Pages.

36. The communication device of claim 34, wherein the memory comprises an electrically erasable programmable read-only memory (EEPROM).

37. The communication device of claim 34, wherein the media configuration information comprises a power class of the communication device.

38. The communication device of claim 34, wherein the media configuration information comprises an alarm associated with the communication device.

39. A method comprising:
receiving, by a host device from a communication device during a non-standard operating mode, one or more packets comprising media configuration information of the communication device over a serial communication interface; and
receiving, by the host device from the communication device during a standard operating mode, data packets over the serial communication interface.

40. The method of claim 39, wherein the media configuration information is included within one or more Auto-Negotiation Next Pages.
